(19) United States
(12) Patent Application Publication
(10) Pub. No.: US 2015/0100602 A1
(43) Pub. Date: Apr. 9, 2015

(54) SYSTEM AND METHOD FOR THIRD PARTY REMOTE ACCESS TO PERSONAL MEDICAL RECORDS

(71) Applicant: AMEKC LLC, Lindenhurst, NY (US)

(72) Inventors: Jorge Mario Lopera, Boulder, CO (US); Rachel Joy Cohen, Boulder, CO (US)

(73) Assignee: AMEKC LLC, Lindenhurst, NY (US)

(21) Appl. No.: 14/045,042

(22) Filed: Oct. 3, 2013

(51) Int. Cl. G06F 21/62

(52) U.S. Cl. CPC G06F 21/6218
USPC 707/783

(57) ABSTRACT

A portable healthcare electronic data security key for an individual that is configured for use in combination with a portable computerized data access device that can wirelessly communicate with the key through complementary close proximity or NFC circuitry such that when the access device is positioned in close proximity to the key, the key communicates a security protocol to the access device that instructs the access device to utilize the Internet (or another communications network) to remotely access and retrieve with the proper authorization provided by the key at least a portion of the individual's electronically stored medical records from a remote database and display those retrieved medical records on the access device's user display. The security protocol can also instruct the access device to send an alert to emergency contacts identified by the individual in the key or in the database.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD

The present disclosure relates to the retrieval of personal medical records and, more specifically, to a system that enables a third party, such as for example an Emergency Medical Technician, to remotely and rapidly access the medical records of an individual being treated in an emergency situation that is incapacitated or otherwise unable to convey such information to the third party.

### BACKGROUND

The statements in this section merely provide background information related to the present disclosure and may not constitute prior art.

When an individual is subjected to a medical emergency, the treating medical personnel's ability to rapidly access that patient's medical records can be very important to the successful treatment of the condition and to the avoidance of medical complications. Indeed, in the time-critical universe of emergency medicine, the availability of the patient's medical records and the speed at which those records can be retrieved and used by the treating emergency medical personnel, can in certain circumstances constitute the very difference between life and death for the patient. When possible, emergency medical personnel often rely upon their patients to inform them of their medical history and medication treatments. Unfortunately, all too often the patient is unconscious, incoherent or otherwise unable to convey this vital information to the emergency medical personnel. Consequently, the emergency medical personnel may be unable to readily obtain the patient's medical information, and resulting time constraints can force treatment of the patient based upon symptoms alone which can require guesswork concerning treatment and the proper administration of medicines.

A number of systems and devices have been developed to provide for the readily available and accessible storage of personal medical records for emergency access. Unfortunately, such systems and devices have various shortcomings in practical application.

For example, wearable engraved or printed personal medical “alert” tags are available, particularly for persons having known allergic reactions. While such tags can convey pertinent medical information, they only contain written materials, and their typically small size limits the amount of information that they can contain. In addition, the information printed or engraved on such “tags” is often vague and outdated. As another example, some more contemporary versions of personal medical “alert” tags have been enhanced with digital data storage capabilities that enable the storage of substantial amounts of data, including extensive medical records. However, these records can also be outdated and can also be corrupted or lost by damage to the tag. Hence, such “alert” tags fail to provide the emergency medical personnel with up-to-date and comprehensive medical information pertaining to that patient that could be crucial in determining the best course of action for the patient under the emergency circumstances.

In addition, some services are available that offer an Internet website to which the emergency medical personnel may go to view the patient's medical information stored on the website. To do so, the emergency medical personnel must find the serial number or code listed on a personal medical “alert” tags worn or carried by the patient, access the Internet, browse to the specific website, enter the serial number or code, and find and download the patient's medical records. While such a system may offer emergency medical personnel access to a patient's up-to-date medical records, the procedure requires manual interactions by the emergency medical personnel and is time consuming in emergency situations. In yet another service, the emergency medical personnel can retrieve a patient's medical information by calling a toll free number. Again, such a service requires manual interactions by the emergency medical personnel and is time consuming when time can be critical.

Cellular telephones and other electronic devices, including for example computer tablets and laptops, that have Internet access are now ubiquitous. Further, it is now becoming commonplace for such devices to incorporate Near Field Communication (“NFC”) components that enable convenient and rapid transfer of electronic data among devices that are positioned in close proximity to one another.

The NFC protocol consists of a collection of standards for “smart” cellular telephones and similar devices, including for example computer tablets and laptop computers, that establish wireless communication with each other by touch or by positioning them in close proximity to one another. Here, “close proximity” is generally understood to mean within a few inches, but may extend to several feet. Electronic devices utilizing the NFC protocols may have powered and unpowered NFC components. Unpowered NFC components are at times referred to as “tags.”

NFC standards encompass a variety of communications protocols and data exchange formats, and are based primarily on existing radio-frequency identification (“RFID”) and is generally considered a form of personal area network (“PAN”). NFC standards are established and defined by the industry through the “NFC Forum”, an industry consortium founded in 2004 by Nokia, Philips and Sony. The NFC Forum currently has over 100 members. The NFC standards include, e.g., ISO/IEC 14443 and FeliCa, ISO/IEC 18092. The NFC Forum also promotes NFC and certifies device compliance.

If properly programmed and configured, NFC devices have the capability to be utilized to convey personal medical records stored at a distant computer server location to a party at a remote location.

It would therefore be desirable to have a means to store an individual's personal medical records that are protected from unauthorized access and yet readily and rapidly accessible to third parties, such as medical personnel, during a medical emergency involving the individual. It would be further desirable for that means to be readily and rapidly available to a wide variety of devices that may be readily accessible or carried by the treating medical personnel, such as for example a cellular telephone, a computer tablet or a laptop computer.

### BRIEF DESCRIPTION OF SEVERAL VIEWS OF THE DRAWINGS

The illustrative embodiments of the present invention are shown in the following drawings which form a part of the specification:

FIG. 1 is a perspective view of a portable healthcare data security key of the present disclosure according to one representative embodiment, the key having a passive NFC circuit.

FIG. 2 is a different perspective view of the portable healthcare data security key of FIG. 1.

FIG. 3 is a side view of the portable healthcare data security key of FIG. 1.

FIG. 4 is a perspective view of an alternative embodiment of a portable healthcare data security key of the present disclosure, the key having a definable data storing magnetic strip.

FIG. 5 is a perspective view of yet another alternative embodiment of a portable healthcare data security key of the present disclosure, the key having an printed bar code.

FIG. 6 is a perspective view of yet another alternative embodiment of a portable healthcare data security key of the present disclosure, the key having an infrared port.

FIG. 7 is a flowchart of a method to use a medical records retrieval system (“MRRS”) of the present disclosure according to one representative embodiment.

FIG. 8 is a block diagram of the medical records retrieval system (“MRRS”) of FIG. 6.

FIG. 9 is a block diagram of a representative computer system suitable for use with a portable healthcare data security key and/or various components of a medical records retrieval system, all according to various embodiments of this disclosure.

FIG. 10 illustrates a representative computer and telecommunications network environment according to one embodiment.

FIG. 11 illustrates a representative computer system environment according to another embodiment.

FIG. 12 illustrates a representative client-server environment according to yet another embodiment.

FIG. 13 illustrates a detailed representative client-server environment according to another embodiment.

It should be understood that throughout the drawings, corresponding reference numerals indicate like or corresponding parts and features.

### DETAILED DESCRIPTION

The following description is merely representative in nature and is not intended to limit the present disclosure or the disclosure's applications or uses. Before turning to the figures and the various representative embodiments illustrated therein, a detailed overview of various embodiments and aspects is provided for purposes of breadth of scope, context, clarity, and completeness.

As described and disclosed herein are various embodiments of devices, systems and methods for accessing an individual's electronically stored personal medical records from a secure remote location using an appliance that is capable of being personally worn or held by the individual and that acts as a key to enable a variety of access devices with Internet or other network connectivity capability to retrieve and display the those medical records no matter the condition of the individual. Hence, the individual's medical information can be retrieved no matter whether the individual is conscious, unconscious, incoherent or otherwise unable or hindered in the ability to communicate. Further, the individual's medical records can be retrieved even when the individual and the treating medical personnel speak different languages.

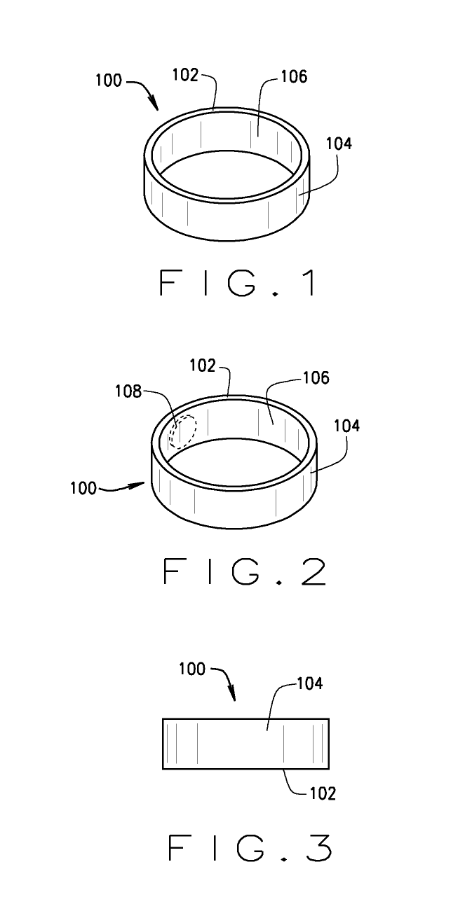

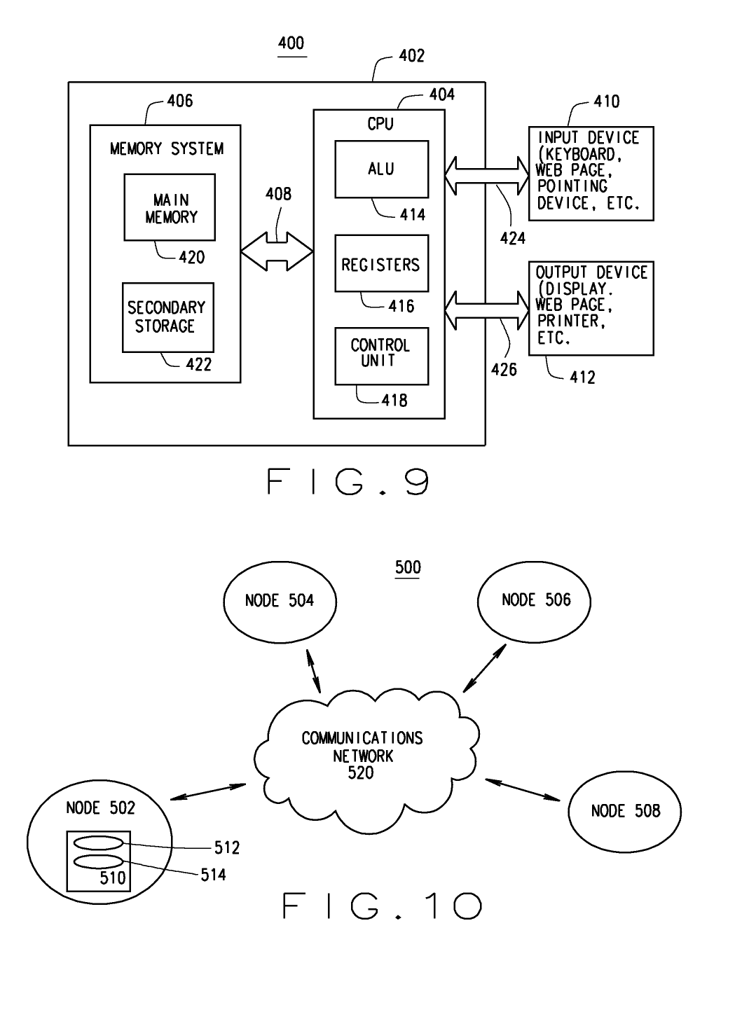

Referring now to FIGS. 1-7, a portable healthcare data security key 100 for an individual 101 having a variety of different components and embodiments is disclosed and illustrated. In one embodiment (FIGS. 1-3, 7), the key 100 is configured as a silicone wristband or bracelet, having a pliant and generally circular body 102 with an outer surface 104 and an inner surface 106. A close proximity interface component in the form of a Near Field Communication (“NFC”) electronic circuit 108, comprising an electronic data memory unit 110 that is operatively associated with the circuit 108 (see FIG. 8), is imbedded within the body 102 between the outer and inner surfaces 104 and 106. Of course, one of ordinary skill in the art will recognize that the key 100 may be configured in a wide array of materials, shapes and sizes. By way of example, the key 100 may be configured as a pendant, a belt buckle, a headband, a cap, an article of clothing, a keychain fob, or any of countless other devices having any variety of particular shapes and sizes so long as the key 100 incorporates in some manner the circuit 108 or a similarly functioning component. Similarly, the key 100 may be comprised of various materials with different properties that may be, for example, flexible or elastic, so long as the materials enable the key 100 to incorporates in some manner the circuit 108 or a similarly functioning component.

In the embodiment of FIGS. 1-3 and 7, the NFC circuit 108 comprises a passive NFC tag manufactured by Mifare™ and having the name “NXP Ultralight”, a 48 byte machine-washable NFC tag that is ISO 14443A compliant. The “NXP Ultralight” provides contactless transmission of data with no stored energy with an operating distance of up to 100 mm, 39 character NDEF text, and 46 bytes of memory in an integrated memory unit 110 that is lockable and re-writable. As an added feature, the Mifare™ “NXP Ultralight” NFC tag has a waterproof rating of IP 68, which means that it can withstand a water pressure of 45 bar for up to 10 hours. Because the circuit 108 is “passive”, it is unpowered and requires activation from a complementary NFC device to enable data communication between the two.

Hence, this embodiment of the key 100 is configured to enable storage of a security protocol 112 (see FIG. 8), which is stored in the key's passive memory and can include a transferrable security code 112 and transferrable computer executable instructions 116 that can, for example, include instructions to access medical records in a database located at a website on the Internet.

Referring further to FIG. 8, a medical records retrieval system (“MRRS”) 200 having a variety of different modules and components and embodiments is illustrated. As shown, the MRRS 200 in one embodiment comprises the key 100, an electronic access device 210, an electronic database server 220 that includes medical records 222 for the individual 101 stored in an electronic data memory unit 224, and a communications network 230 comprising the Internet or other network through which the access device 210 can access the database 221 at the server 220. The server 220 also has a computer processor 226 that operates the memory unit 224, including the database 221, and screens all access to both. The server 220 further has a network portal or interface 228, having a particular Internet address that is operatively associated with the computer processor 226. The interface 228, in conjunction with the computer processor 226, provides for access from the communications network 230 to the database 221. Further, a database security interface 229, operatively associated with the computer processor 226, is provided between the network interface 228 and the database 221. The computer processor 226 uses the database security interface 229 as a filter to screen access to the medical records 222 in the database 221. Such medical records or files 222 may include for example any portion of, or all of, the individual's her medical information such as current and past medication history, allergies, medical history, and emergency contacts.

The access device 210 comprises a cellular telephone having an NFC electronic circuit 212, a network interface 213, an electronic data memory unit 214, a user interface 216, a user display 218, and a computer processor 219 that operates the NFC circuit 212, the network interface 213, the memory unit 214, the user interface 216 and the a user display 218. NFC enabled cellular telephones are becoming commonplace, and virtually any model of cellular telephone having NFC circuitry 212 compatible with the NFC circuit 108 can be utilized for the MRRS 200. For example, as of the drafting of this application, a nonexclusive representative listing of NFC compliant cellular telephones includes: Acer Liquid Express E320 and E330; Alcatel One Touch 996, Asus Padfone 2 and Padfone Infinity; Blackberry Bold 9790, Bold 9900/9930, Curve, Q10 and Z10; Casio G'zOne Commander 4G LTE; Google/Samsung Galaxy Nexus, Amaze 4G, Desire C, EVO 4F LTE Incredible S, J Butterfly, certain One models, Windows Phone 8X; Intel AZ210; LG certain Optimus models, Prada 3.0; select Motorola Razr models and Photon Q; Google Nexus 4 and S; certain Nokia models and certain Nokia Lumia models; certain Samsung Galaxy models; and certain Sony Xperia models.

Of course, while depicted in MRRS 200 as a cellular telephone, the access device 210 may alternately take the form any of a number of electronic devices, such as for example, a computer tablet or a laptop computer that have NFC circuitry 212 compatible with the NFC circuit 108.

The NFC circuit 212 of the access device 210 is complementary to the NFC circuit 108 of the key 100 so as to enable the access device 210 and the key 100 to wirelessly communicate electronic data to each other through their respective NFC circuits 108 and 212. In addition, the access device 210 is also configured to use the network interface 213 to communicate through the communications network 230. For the embodiment of MRRS 200, the network interface 213 comprises circuitry and computer executable instructions for wireless Internet access through the cellular network utilized by the access device 210. In this way, the access device 210 may reach the database 221 in which are stored the medical records 222 pertaining to the individual 101.

Unfortunately, as can be appreciated, any electronic device that has access to the communications network 230, and not just the access device 210, could possibly communicate with the database 221 and thereby expose the medical records 222 to unauthorized access and disclosure. Hence, it is contemplated that to protect against such unauthorized access, the medical records 222 stored in the database 221 will be protected by security measures such as for example the database security interface 229, which could for example require entry of an electronic code or cypher to allow access to the records. Consequently, the access device 210 alone cannot access the medical records 222.

Rather, the MRRS 200 is configured to enable a third party, such as for example a paramedic or other medical care provider in possession of the access device 210, to wirelessly access and retrieve the individual's medical records 222 from a remote electronic database 221 through the communications network 230, in this case the cellular telephone network and the Internet, when the access device 210 is in positioned close proximity to the key 100. When so positioned, the NFC circuit 212 in the access device 210 activates the passive NFC circuit 108 in the key 100 to trigger the key 100 to communicate the security protocol 112 to the access device 210 through the NFC circuits 108 and 212.

Pursuant to NFC protocols and standards, the key 100 must be positioned in close proximity to the access device 210 for the key's NFC circuit 108 to communicate with the access device's NFC circuit 222. In this context, “close proximity” is generally understood to mean physically touching or spaced apart at a range of no more than a few inches. However, this separation range may in some configurations extend to several feet, depending upon the design parameters and the specific circuitry utilized.

It will be recognized that the requirement for the NFC circuits 108 and 222 to be in close proximity to one another to function also provides an added degree of security. That is, because the key 100 does not communicate with electronic devices beyond a very short range, the likelihood of that the security protocol 112 will be transmitted to and intercepted by unauthorized persons or electronic devices is remote.

In the embodiment of FIGS. 1-9, the security protocol 112 includes a code or cypher 114 that is configured to allow access to the medical records 222 stored in the database 221, the Internet website address at the network interface 228 for the database 221, and computer executable instructions 116. Upon transmission of the security protocol 112 from the key 100 to the access device 210, the computer executable instructions 116 instruct the access device 210 to automatically link to the Internet address of the interface 228 for the database 221, properly input the code or cypher 114 when prompted by the database 221 to allow the access device 210 access to the medical records 222 stored in the database 221, download the medical records 222 from the database 221 to the access device 210, and display the medical records 222 on the user display 218 for the access device 210. This retrieval of the individual's medical records 222 takes place in a matter of seconds through the MRRS 200 utilizing NFC technology and Internet connectivity as disclosed herein.

While we have described to this point in the detailed description certain configurations that may be encompassed within the disclosed embodiments of this invention, other alternative configurations, that would now be apparent to one of ordinary skill in the art, may be designed and constructed within the bounds of our invention as set forth in the claims. Moreover, both of the above-described novel portable healthcare data security key 100 and medical records retrieval system (“MRRS”) 200 can be arranged in a number of other and related varieties of configurations without expanding beyond the scope of our invention as set forth in the claims.

For example, the security protocol 112 can be configured to communicate a set of computer executable instructions 116 that enable the access device 210 to scan and selectively download portions of the medical records 222 from the database 221. In another embodiment, the key 100 can be configured to allow a user to input all or a portion of the security protocol 112 into the key 100, including for example, the website address for the interface 228, the file name or names in the database 221 containing the medical records 222, and/or the access code 114. Such a user modifiable key 100 can be configured to allow repeated user inputs, a limited number of user inputs or just a single user input. In a contrasting embodiment, the key 100 can have the security protocol 112 preloaded by the manufacturer and preclude user input.

In yet another alternative, the key 100 can be configured to provide additional access protocols (e.g., a telephone number or a website) and can provide certain limited medical records either printed on the key or stored in the key's memory accessible by an access device through the key's close proximity interface 108.

While having been discussed herein in the context of providing third parties with remote access to an individual's medical records, the key 100, and its associated systems and methods, may also be used to allow certain third parties access to other types of information. For example, the key 100 may provide a third party access only through one or a limited number of proprietary or dedicated access devices 210 to certain of the individual's financial records or to a copy of the individual's estate records or will.

Further, the key 100, and its associated systems and methods, can be configured to include additional security measures beyond the security protocol 112 that must be passed in order to allow the access device 210 to access the individual's medical records 222. For example, the system or method MRRS 200 may require that the third party input a code or cypher that is not provided by the key 100. As another example, the key 100 may be configured to be linked to another device to allow the access device 210 access to the medical records 222.

In various embodiments the close proximity NFC circuit 108 may assume a multitude of configurations. For example, initially the circuit 108 may be either active or passive. That is, as described above, a “passive” NFC circuit is typically unpowered and requires activation from a complementary NFC device to enable data communication between the two. In contrast, an “active” NFC circuit is typically powered and searches out a complementary NFC circuit with which to initiate data communications. Further, the NFC circuit 108 may be configured to communicate with other NFC circuits through a variety of means, including for example, radio waves, infrared light and magnetic fields. Some of these various configurations of the NFC circuit 108 will be discussed by way of example in alternate embodiments of the invention in this disclosure. In addition, the NFC circuit 108 and may be configured to communicate through one or more of a variety of communication protocols, such as for example, ISO/IEC 14443 and FeliCa, ISO/IEC 18092.

In yet another variant, the NFC circuit 108 may alternatively be positioned along the outer surface 104 of the body 102. Similarly, the NFC circuit 108 may comprise, for example, an operatively associated touch pad that can be positioned along the outer surface 104 of the body 102 even if the circuit 108 is positioned along the inner surface 106 or buried within the body 102 of the key 100. Such alternate configurations allow for direct contact between the NFC circuit 108 and the NFC circuit 212 of the access device 210, which may be required for certain “touch” NFC devices to function properly.

Although in the embodiment discussed above the communications network 230 is wireless as it includes communications through a cellular telephone network and the Internet, alternate embodiments of the MRRS 200 may have a communications network 230 that is not wireless or that comprises portions that may be other than wireless. For example in an alternate embodiment for the MRRS 200, the access devices 210 may be “hard-wired” to the communications network 230, which in turn may wirelessly connected to the network portal 228 or which may be “hard-wired” to the network portal 228.

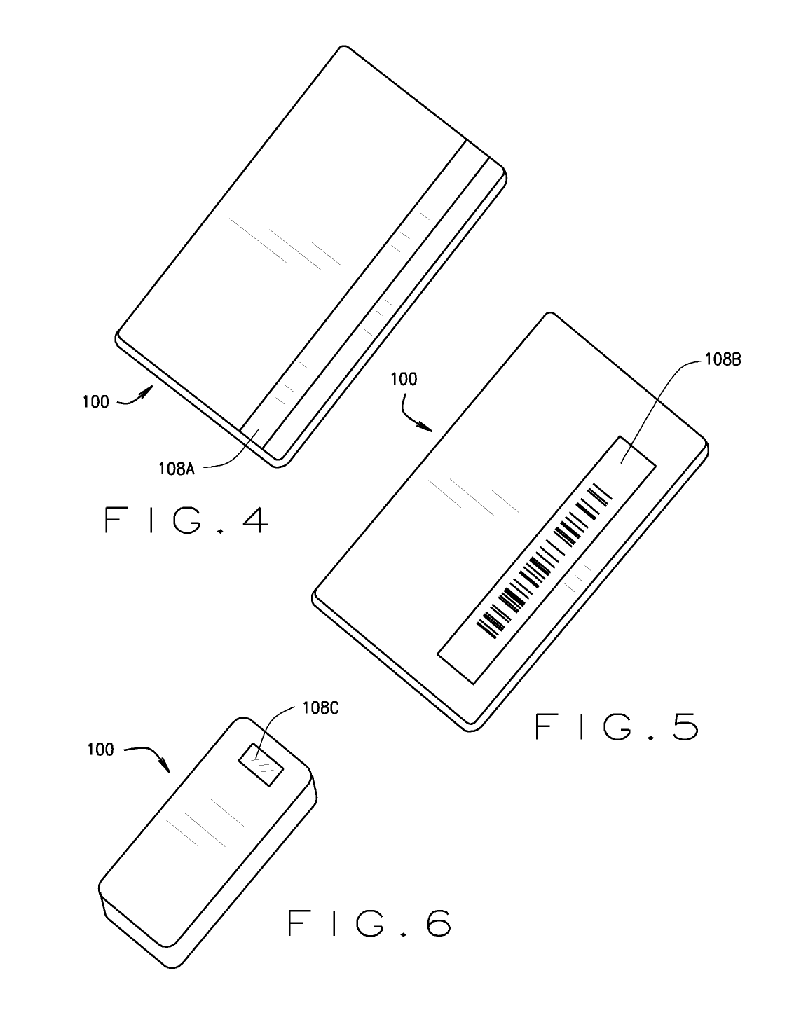

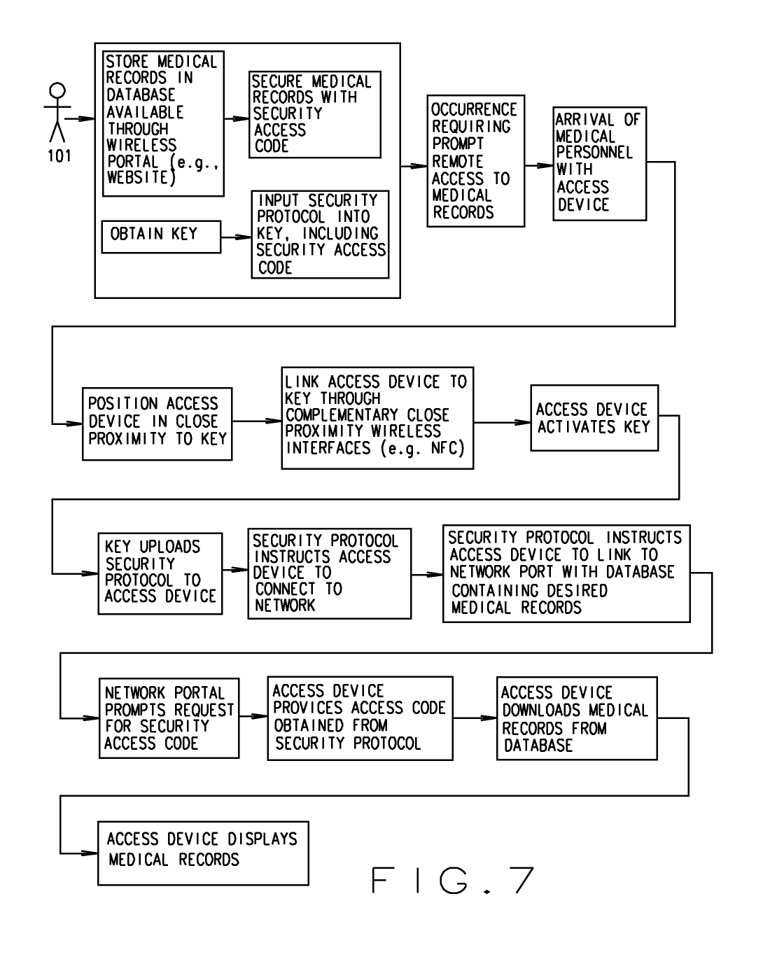

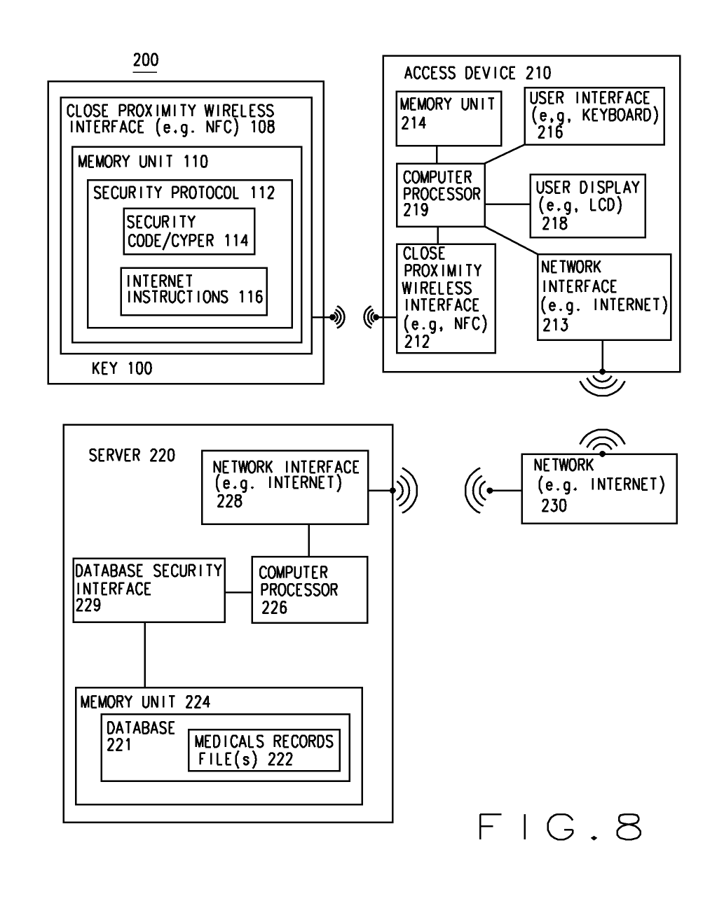

Moreover, the communication circuit 108 need not be fully NFC compliant, but may comprise some other form of communication circuitry that is configured to communicate electronic data from the key 100 to a an access device 210 when the key 100 and the access device 210 are positioned in close proximity to one another. For example, in FIG. 4 it can be seen that in place of the NFC circuit 108 the key 100 may comprise a definable data storing magnetic strip 108A containing the security protocol 112, in which case the access device 210 will comprise a complementing electronic strip reader 212A (not shown) configured to read the magnetic strip 108A. Similarly, in FIG. 5 it can be seen that in place of the NFC circuit 108 the key 100 may comprise a printed bar code 108B containing the security protocol 112, in which case the access device 210 will comprise a complementing bar code reader 222B configured to read the bar code 108B. In addition, in FIG. 6 it can be seen that the circuit 108 may comprise an infrared port 108C, in which case the access device 210 will comprise a complementing infrared port 212C configured to operatively communicate with the port 108C.

### Operational Computer Environments

Referring to FIG. 9, an operating environment for an illustrated embodiment of the present invention is a computer system 400 with a computer 402 that comprises at least one high speed processing unit (“CPU”) 404, in conjunction with a memory system 406 interconnected with at least one bus structure 408, an input device 410, and an output device 412. These elements are interconnected by at least one bus structure 412.

The illustrated CPU 404 is of familiar design and includes an arithmetic logic unit (“ALU”) 414 for performing computations, a collection of registers 414 for temporary storage of data and instructions, and a control unit 416 for controlling operation of the system 400. Any of a variety of processors, including at least those from Digital Equipment, Sun, MIPS, Motorola, NEC, Intel, Cyrix, AMD, HP, and Nexgen, are equally preferred for the CPU X. The illustrated embodiment of the invention operates on an operating system designed to be portable to any of these processing platforms.

The memory system 406 generally includes high-speed main memory 420 in the form of a medium such as random access memory (“RAM”) and read only memory (“ROM”) semiconductor devices, and secondary storage 422 in the form of long term storage mediums such as floppy disks, hard disks, tape, CD-ROM, flash memory, etc. and other devices that store data using electrical, magnetic, optical or other recording media. The main memory 420 also can include video display memory for displaying images through a display device. Those skilled in the art will recognize that the memory system 406 can comprise a variety of alternative components having a variety of storage capacities.

The input device 410 and output device 412 are also familiar. The input device 410 can comprise a keyboard, a mouse, a physical transducer (e.g., a microphone), etc. and is interconnected to the computer 402 via an input interface 424. The output device 412 can comprise a display, a printer, a transducer (e.g., a speaker), etc., and be interconnected to the computer 402 via an output interface 426. Some devices, such as a network adapter or a modem, can be used as input and/or output devices.

As is familiar to those skilled in the art, the computer system 400 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 406.

In accordance with the practices of persons skilled in the art of computer programming, the present invention is described below with reference to symbolic representations of operations that are performed by the computer system 400. Such operations are sometimes referred to as being computer-executed. It will be appreciated that the operations which are symbolically represented include the manipulation by the CPU 404 of electrical signals representing data bits and the maintenance of data bits at memory locations in the memory system 406, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 406.

### Node-Node Environment

In one or more embodiments, the invention is practiced in the environment of a computer network or networks. The network can include a private network, or a public network (for example the Internet, as described below), or a combination of both. The network includes hardware, software, or a combination of both.

As skilled persons will recognize, from a high-level, telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. Skilled persons will recognize that the distinction between hardware and software is not always easily defined, with the same or similar functions capable of being performed with use of either. This is especially true for functionality associated with the communications between processes.

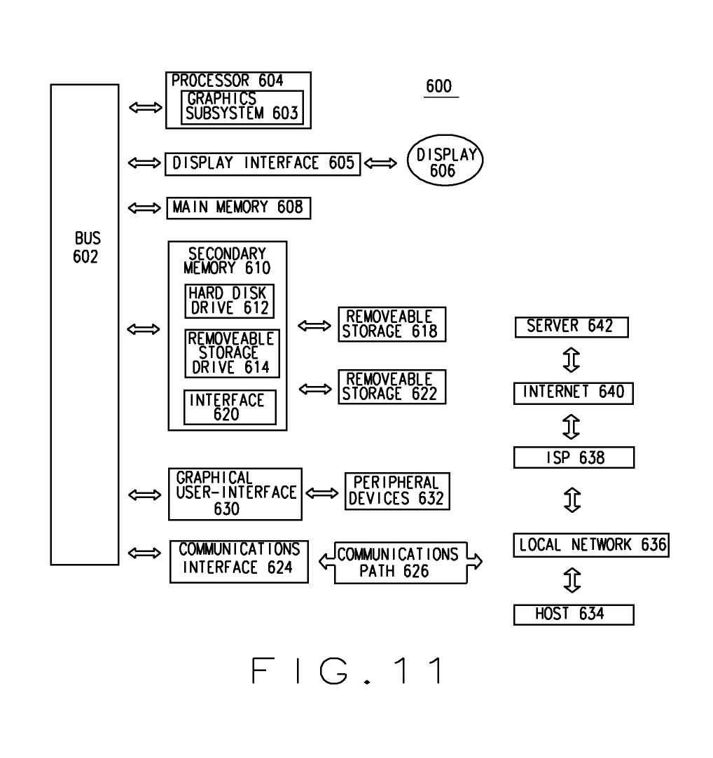

FIG. 10 illustrates a representative computer and telecommunications network environment 500. Environment 500 includes nodes 502, 504, 506 and 508, which include hardware, software, or a combination of hardware and software. Nodes 502-508 are interconnected via communications network 520. Each node 502-508 includes one or more processes 512, 514, executable by processors 510 incorporated into the nodes. It is possible that a single process 512 can be run by multiple processors 510, or that multiple processes 512, 514 can be run by a single processor 510. Additionally, each of nodes 502-508 can provide an interface point between network 500 and the outside world, and can incorporate a collection of subnetworks.

Persons of skill in the art will appreciate that the “software” processes 512, 514 include software and/or hardware entities that perform work over time, such as tasks, threads, and intelligent agents. Also, each process 512 can refer to multiple processes, for carrying out instructions in sequence or in parallel, continuously or intermittently.

In one embodiment, the processes 512, 514 communicate with one another through interprocess communication pathways (not labeled) supporting communication through any communications protocol. The pathways can function in sequence or in parallel, continuously or intermittently. The pathways can use any of the communications standards, protocols or technologies, described below with respect to communications network 520, in addition to standard parallel instruction sets used by many computers.

Nodes 502-508 include any entities capable of performing processing functions. Examples of nodes 502-508 that can be used with the present invention include computers (such as personal computers, workstations, servers, or mainframes), handheld wireless devices and wireline devices (such as personal digital assistants (PDAs), modern cell phones with processing capability, wireless e-mail devices including BlackBerry.™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between nodes 502-508 is made possible by communications network 520. A node 502-508 can be connected either continuously or intermittently with communications network 520. As an example, in the context of the present invention, communications network 520 can be a digital communications infrastructure providing adequate bandwidth and information security.

Communications network 520 can include wireline communications capability, wireless communications capability, or a combination of both, at any frequencies, using any type of standard, protocol or technology. In addition, in the present invention, communications network 520 can be a private network (for example, a VPN) or a public network (for example, the Internet).

A non-inclusive list of representative wireless protocols and technologies used by communications network 520 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN).

Also included are various generation wireless technologies, as set forth in Table 1. It should be noted that the definitions provided therein and the other tables herein are provided for convenience of understanding the concepts of the present invention, and not by way of limiting the features and functions of the specification.

A representative non-inclusive list of primarily wireline protocols and technologies used by communications network 520 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

### Mobile Telephony Terms

1G refers to the first generation wide area wireless (WWAN) communications systems, dated in the 1970s and 1980s. These devices are analog, designed for voice transfer and circuit-switched, and include AMPS, NMT and TACS.

2G refers to second generation WWAN communications, dated in the 1990s, characterized as digital, capable of voice and data transfer, and include HSCSD, GSM, CDMA IS-95-A and D-AMPS (TDMA/IS-136).

2.5G refers to the generation of WWAN communications between 2G and 3G.

3G refers to third generation WWAN communications systems recently coming into existence, characterized by data rates of 144 Kbps to over 2 Mbps (high speed), being packet-switched, and permitting multimedia content, including CPRS, 1xRTT, EDGE, HDR, W-CDMA.

4G refers to fourth generation WWAN communications systems, expected to come in the years 2006-2010, characterized by very high-speed (over 20 Mbps) data rates, permitting high-resolution for video.

As noted, each node 502-508 includes one or more processes 512, 514, executable by processors 510 incorporated into the nodes. In a number of embodiments, the set of processes 512, 514, separately or individually, can represent entities in the real world, defined by the purpose for which the invention is used.

Furthermore, the processes 512, 514 and processors 510 need not be located at the same physical locations. In other words, each process 512, 514 can be executed at one or more geographically distant processor 510, over for example, a LAN or WAN connection.

Persons of skill in the art will appreciate a great range of possibilities for practicing the invention using different networking hardware and software configurations.

### Machine Instructions Environment

In one or more embodiments, the steps of the present invention are embodied in machine-executable instructions. The instructions can be used to cause a processing device, for example a general-purpose or special-purpose processor, which is programmed with the instructions, to perform the steps of the present invention.

Alternatively, the steps of the present invention can be performed by specific hardware components that contain hardwired logic for performing the steps, or by any combination of programmed computer components and custom hardware components.

For example, the present invention can be provided as a computer program product. In this environment, the invention can include a machine-readable medium having instructions stored on it. The instructions can be used to program any processor (or other electronic devices) to perform a process according to the present invention.

The machine-readable medium can include, for example, floppy diskettes, optical disks, CD-ROMs, and magneto-optical disks, ROMs, RAMs, EPROMs, EEPROMs, magnet or optical cards, or other type of media/machine-readable medium suitable for storing electronic instructions, but is not limited to the foregoing.

In addition, the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

### Computer Hardware Environment

In one embodiment, illustrated in FIG. 11, a node such as 502 comprises a computer system 600. Computer system 600 includes bus 602, processor 604 (including graphics subsystem 603), display interface 605, display 606, main memory 608, secondary memory 610 (including hard disk drive 612, removable storage drive 614, and interface 620), removable storage units 618, 622, graphical user-interface 630, peripheral devices 632 and communications interface 624. Computer system 600 is also connected via communications path 626 to external networks. Various embodiments are described in terms of this example computer system. After reading this description, it will be apparent to a person skilled in the relevant art how to implement the invention using other computer systems and/or computer architectures.

Processor 604, which can represent multiple processors, is connected to a communications bus 602. Graphics subsystem 603, shown as associated with processor 604, can be implemented as one or more processor chips. In fact, graphics subsystem 603 can be included as part of processor 604 as shown in FIG. 11 or as a separate graphics engine or processor. Graphics data is output from the graphics subsystem 603 to the bus 602.

Display interface 605 forwards graphics data from the bus 602 for display on the display unit 206. This graphics data includes graphics data for the screen displays described herein.

Main memory 608 can be a random access memory (RAM), and can also include a secondary memory 610. In the present invention the secondary memory 610 can include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618 represents a floppy disk, magnetic tape, optical disk, etc., which is read by and written to by removable storage drive 614. As will be appreciated, the removable storage unit 618 includes a computer usable storage medium having stored therein computer software and/or data.

In alternative embodiments, secondary memory 610 can include other similar means for allowing computer programs or other instructions to be loaded into computer system 600. Such means can include, for example, a removable storage unit 622 and an interface 620. In the present invention examples can also include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Graphical user interface module 230 transfers user inputs from peripheral devices 632 to bus 206. These peripheral devices 632 can be a mouse, keyboard, touch screen, microphone, joystick, stylus, light pen, or any other type of peripheral unit.

Computer system 600 can also include a communications interface 624. Communications interface 624 allows software and data to be transferred between computer system 600 and external devices via communications path 626. Examples of communications interface 624 that can be used with the present invention include a standard or cable modem, a DSL connection, a network interface (such as an Ethernet card), a communications port, a LAN connection, a WAN connection, etc. Computer programs and data transferred via communications interface 624 are in the form of signals which can be electronic, electromagnetic, optical or other signals capable of being received by communications interface 624, via communications path 626. Note that communications interface 624 provides a means by which computer system 600 can interface to a network such as the Internet.

The present invention can be implemented using computer programs (i.e., “software,” or “computer control logic”) running on Processor 604. The software can be originally stored as a “computer program product” on removable storage device 618 or hard disk drive 612. Therefore, computer program product refers to means for providing software to computer system 600.

Computer programs can also be stored in main memory 608 and/or secondary memory 610. Computer programs can also be received via communications interface 624. Such computer programs, when executed, enable the computer system 600 to perform the features of the present invention as discussed herein. In particular, the computer programs, when executed, enable the processor 604 to perform the features of the present invention.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant arts.

In the example environment shown, communication interface 624 provides a two-way data communication coupling via a communications path 626 to a local network 636. For example, if communication interface 624 is an integrated services digital network (ISDN) card or a modem, communication interface 624 provides a data communication connection to the corresponding type of telephone line, which comprises part of communications path 626. If communication interface 624 is a local area network (LAN) card, or connects to a LAN 636, then it can provide a data communication connection via communications path 626 to a compatible LAN. Wireless links are also possible. In any such implementation, communication interface 624 sends and receives electrical, electromagnetic or optical signals which carry digital data streams representing various types of information.

Communications path 626 typically provides data communication through one or more networks to other data devices. For example, in the present invention communications path 626 can provide a connection through local network 636 to host computer 634 or to data equipment operated by an Internet Service Provider (ISP) 638. In turn, ISP 638 provides data communication services through the worldwide packet data communication network now commonly called the “Internet” 240, described in detail in other embodiments.

Local network 636 and Internet 640 both use electrical, electromagnetic or optical signals that carry digital data streams. The signals through the various networks and the signals on communications path 626 and through communication interface 624, which carry the digital data to and from computer 200, are representative forms of carrier waves transporting the information.

Computer system 600 can send messages and receive data, as well as computer programs, through the network or networks, communications path 626, and communication interface 624. If the network used is the Internet, server 642 can transmit a requested code for an application program through Internet 640, ISP 638, local network 636 and communications path 626. Examples of such applications are the application programs run by application servers and database servers, as described in detail below.

### Client-Server Environment

In one embodiment, the aforementioned nodes 502-508, processor 510, and processes 512, 514 running on the processor, are described by virtue of their functions with respect to information retrieval within a network.

Specifically, a node that requests information is termed a “client” and a node that transmits the requested information is termed a “server.” A node can have the dual roles of serving as both a client as well as a server.

The processes running on the clients are termed client applications, and the processes running on a server are termed server applications. Information exchange occurs between the server application providing the information or services, and the client application receiving the provided information and services.

FIG. 12 illustrates a representative client-server environment 700. Client-server environment 700 includes the aforementioned communications network 520, which can be a national or an international network. It also includes a number of clients 704, 706 and 708, and a number of servers 710, 712 and 714. The clients 704-708 and the servers 710-714 are nodes connected to network 520, defined by their respective information retrieval functions.

Client 704 includes a client application 716, which is an information requesting or receiving application associated with client 704. Client application 716 either runs on client 704 or runs on another node and is passed to client 704.

Server 710 includes a server application 718, which is an information retrieval application associated with server 710. Server application 718 either runs on server 710 or runs on another node and is passed to server 710.

In operation, client application 716 is executed on client 704. In response, client 704 issues a request for information transmitted over network 520. The request is received by server 710, which executes server application 718. The requested information and/or services are then transmitted back to client 704 over network 520.

### Internet and World Wide Web Environment

In these embodiments, an introduction of the Internet and how it is used in the context of the present invention is provided. As noted, network 520 can be any type of network, either private or public. In one or more embodiments, environment 700 (including network 520) refers to the Internet and World Wide Web (Web). In these embodiments, clients and servers transmit information in formats and media acceptable to the Internet and Web.

Internet refers to a worldwide system of interconnected computer networks that use the Transmission Control Protocol/Internet Protocol (TCP/IP) set of protocols. TCP/IP, in turn, typically refers to a bundle of network protocols, including: (i) the IP, a network layer protocol where unique IP addresses identify each network and each of its hosts, (ii) TCP, a connection-oriented protocol, where a connection is established via handshakes before any data is transmitted and (iii) certain application layer protocols, including telnet and file transfer protocol (FTP).

The parts of the Internet that are most widely used are electronic mail (e-mail) and the aforementioned Web. The Web is a network of computers located all over the world. These international computer networks can be comprised of clients and servers that users access to locate resources.

All the clients 704-708 and servers 710-714 in the Web can communicate with each other, and normally use a communication standard called Hypertext Transfer Protocol (HTTP). HTTP is an application protocol, i.e. a set of rules, for exchanging files on the Web that runs on top of TCP/IP.

The information on the Web is stored in documents called Web pages, which are files stored on the servers 710-714 comprising the Web. The clients 704-708 request the Web pages from the servers 710-714 (specifically server applications 718 running on the servers 710-714). More specifically, client applications 716 running on the clients 704-708 request the Web pages from server applications 718 running on the servers 710-714.

### Displaying Information and Navigating on the Web

In these embodiments, the displaying of information and navigating on the Web in the context of the present invention is provided.

The client applications 716 are typically called Web browsers. Examples of well-known browsers 716 that can be used with the present invention include Spry's Mosaic, Microsoft's Internet Explorer, and Netscape's Navigator. Browsers 716 are capable of understanding a variety of program languages used to design the Web pages, as well as protocols used to transmit the Web pages.

Web browsers 716 have varying levels of sophistication and functionality. Each screen of information includes such items as highlighted words, graphics, menu choices, through which users can hyperlink (or “link”) to retrieve further information, either from the client 704-708 itself (for local files) or from servers 710-714 located on the Web. Table 2 contains common Internet terms known to skilled persons.

The manner of displaying the retrieved informational content in a web browser 716 is primarily according to formatting and display languages. Examples of formatting and display languages that can be used with the present invention include Hyper Text Markup Language (HTML), Extensible Markup Language (XML), Extensible HyperText Markup Language (XHTML), and Cascading Style Sheets (CSS).

HTML is used to create text files that contain markup tags, which inform the browser how to display the page. HTML files must have an “htm” or “html” file extension, and can be created using a simple text editor. XML is a markup language, permitting users to define their own markup tags. The markup tags in XML are not predefined as with HTML. XML uses a Document Type Definition (DTD) or an XML Schema to describe the data. While HTML was designed to display data, focusing on how the data appears, looks, XML was designed to describe data, focusing on the data itself, providing the ability to structure, store, and to send information. XML is pared-down version of Standard Generalized Markup Language (SGML), specifically designed for Web documents. SGML is a comprehensive system for the organization and tagging of document elements. Rather than specifying particular formatting, SGML specifies the rules for tagging elements. XHTML is the same as a version of HTML referenced as HTML 4.01. It is HTML defined as an XML application and applies a strictly defined version of HTML. CSS is used to design stylesheet pages, which define how the document is displayed or printed to the browser. CSS sheets can be attached to the HTML document itself. The cascading feature supported by CSS permits a single document to use two or more stylesheets, which are applied according to specified priorities.

The manner of formatting the information for retrieval from servers 710-714 and transmitting the retrieved information over network 520 are determined by protocols. A variety of protocols can be used to implement the present invention over the Internet, including the aforementioned HTTP, FTP, telnet, as well as, for example, Internet Relay Chat (IRC).

The main protocol (or set of rules for navigation and exchanging of files between clients and servers) used on the Web is HTTP, designed for exchanging files running on top of TCP/IP. HTTP not only defines how messages are formatted and transmitted, but also what actions Web server applications 718 and browsers 716 should take in response to various commands.

The act of using a client browser 716 to download a Web page located at a server application 718 can also be called navigating the Web, or browsing the Web, or linking to Web sites on the Web. Each Web page has a Web address called a Uniform Resource Locators (URLs). Consequently, Web pages are located by linking to the URL of a Web page and displaying it in the browser 716. Users can link to Web pages by selecting or clicking on menu choices, highlighted words, or graphics associated with URLs. When a user enters a URL in his/her browser, or otherwise attempts to link to a website, it causes an HTTP command to be sent to the appropriate Web server, directing it to fetch and transmit the requested Web page.

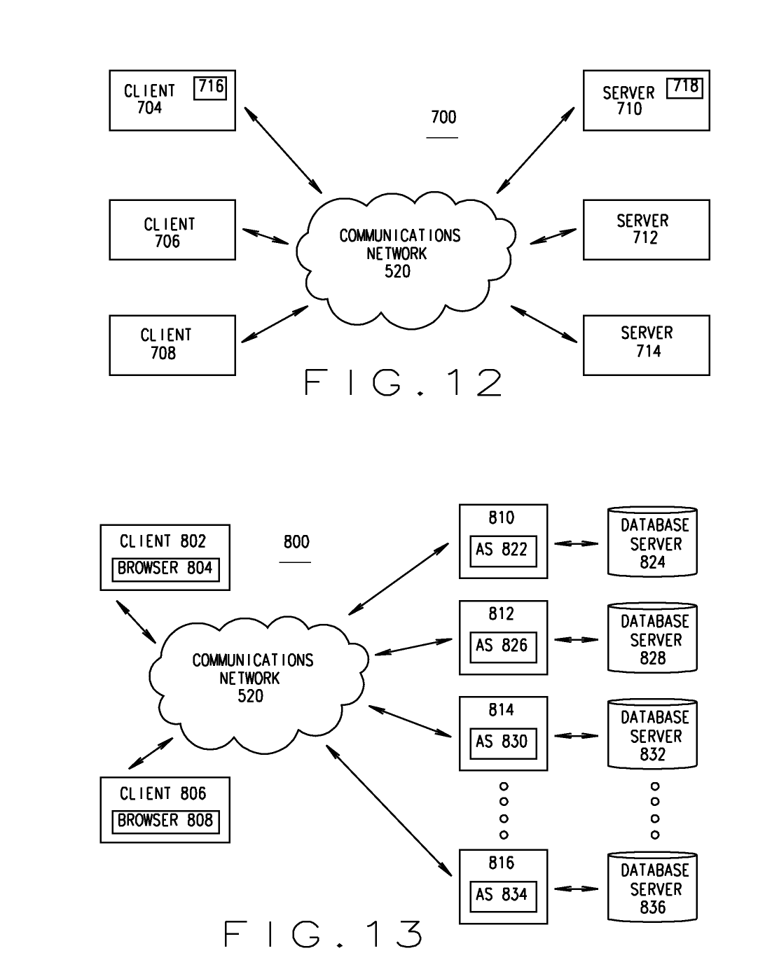

FIG. 13 illustrates a detailed representative client-server environment 800. Environment 800 of FIG. 13 includes the aforementioned communications network 520, a plurality of clients 802, 806 and a plurality of servers 810, 812, 814, 816, connected to network 520. The servers are shown connected to a plurality of database servers (DS's). Specifically, server 810 is connected to DS 824, server 812 is connected to DS 828, server 814 is connected to DS 832, and server 816 is connected to DS 836.

The clients 802, 806 and the servers 810-816 are nodes connected to network 520, defined by their respective information retrieval functions. Client 802 includes a client application 804 (e.g., a Browser), which is an information requesting or receiving application associated with client 802, and client 806 includes a client application 808 (e.g., a Browser), which is an information requesting or receiving application associated with client 806. Client applications 804, 808 can run either on clients 802, 806, respectively, or can run on another node and are then passed to the clients 802, 806. In one or more embodiments, the client applications 804, 808 are web browsers.

Servers 810-816 include a variety of processes, including operating systems, web server applications and application servers. The operating systems, which can also be called platforms, are the software programs that applications use to communicate with the physical parts of the servers 810-816. Examples of operating systems that can be used with the present invention include: Linux™, Sun Solaris™, Windows NT/2000™, Cobalt RaQ™, and Free BSD™, although any operating systems known or anticipated can be used.

The web server applications are software running on servers 810-816 that make it possible for the client browsers 804, 808 to download stored web pages. These applications also coordinate streaming audio, video, and secure e-commerce, and can be integrated with databases (as described below) for information retrieval. Examples of web server applications that can be used with the present invention include: Apache™, Microsoft's Internet Information Server (IIS)™, O'Reilly & Associates WebSite Pro™, Netscape's FastTrack Server™, and StarNine's WebSTAR™ (for Macintosh), although any operating systems known or anticipated can be used.

The application servers sit on top of the formatting and display languages (for example, HTML) that a request from clients 802, 806 generate and translated the request for databases. Upon receiving information from databases, the application servers will translate this information back to the formatting and display languages and sent a response back to the browser. In one or more embodiments, the application server software resides at the servers 810-816, although with cross-platform programming technology, software performing the same functions can reside at clients 802, 806 as well. In one or more embodiments, the application servers will insert strings of programming code into the formatting and display language, with client browsers 804, 808 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 802, 806.

The variety of processes running on servers 810-816 can be written using any program languages and types. Some or all of the programs can be cross-platform applications that additionally to running on the servers (or instead of running thereon) run on the clients 802, 804. Examples of cross-platform programs are Java applets, which run on clients, and servlets, which run on servers. Examples of programming languages that can be used with the present invention include: CGI™, Perl™, Java™, VBScript™, Python™, Microsoft ASP™ Java™, C++, Visual Basic, Enterprise JavaBean (EJB), although any languages known or anticipated can be used.

For the convenience of condensing terminology, the aforementioned applications working, which work together on the servers 810-816 (or instead are processed at other nodes and passed to servers 810-816) are referred to as “application servers.” FIG. 13 illustrates applications servers (AS's) 822, 826, 830, 834 respectively running on clients 810, 812, 814, 816. In operation, client browsers 804, 808 are used to issue requests for information, or queued to transmit information, over network 520. Requests and responses are handled by servers 810-816 via running of AS's 822, 826, 830, 834, which in turn transmit information over network 520 for display by browsers 804, 808.

In one or more embodiments, additional functions required of AS's 822, 826, 830, 834 will be to connect the web servers 810-816 to, for example, back-end data resources such as relational tables, flat files, e-mail messages, and directory servers. In representative embodiments, additional programs incorporated in AS's 822, 826, 830, 834 typically called “middleware,” database utilities, or database management systems (DMBS) can be used, among other known or anticipated database methods.

For example, the AS's 822, 826, 830, 834 can include their own internal DBMS's, or DBMS's of other nodes, or the DBMS's labeled database servers (DS's) 824, 828, 832, 836. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 802, 806, for example, or at server 822-824, for example, and returns a result to the user, for example in the form of a relational table viewable in browsers 804, 808. The DBMS can refer to any type of database, including a relational DBMS (RDBMS), LDAP™, VSAM™, IMS™, Active Directory Services™, message stores, to name a few.

In one or more embodiments, the DBMS is an RDBMS that uses relational database to retrieve information from the database. In one or more embodiments, the relational database uses structured query language (SQL™), including SQL defined according to International Standards Organization (ISO) and American National Standards Institute (ANSI) standards, or follow these standards with additional language constructs. In one or more representative embodiments, AS's 822-824 are respectively connected to DS's 824-836 via an application programming interface (API), including for example the open database connectivity (ODBC™), Java database connectivity (JDBC™), APIs.

In one or more embodiments, additional interfaces are used that can be employed for multiple types of databases, not just relational databases. One example is Microsoft's OLE-DB™, that provides access to all types of information, whether stored in RDBMS™, VSAM™, IMS™, Active Directory Services™, message stores, among others.

Any types of DBMS platforms can be used in the present invention. Representative platforms employed include Sun Microsystems' Java™, 2 Platform, Enterprise Edition (J2EE)™, that contains an Enterprise JavaBeans™. (EJB) server-side component architecture, and Microsoft's Windows™ Distributed interNet Applications Architecture (Windows DNA™), which contains the COM+™ server-side component architecture.

### Internet Terms

ActiveXControl is a COM object that can be loaded from a server via inter- or intranet and run on any NT-client.

Browser (or Web Browser) is a computer application that fetches Web pages from servers on the Internet and displays them on the user's local machine.

CML (Chemical Markup Language) is an XML schema designed for handling information concerning chemical substances.

COM (Component Object Model) is an MS-paradigm for connecting components, which has implemented the base technology for COM on the NT platform.

CSS Cascading Style Sheets refers to a W3C Recommendation for files that when attached to a document will describe how the document is to be displayed or printed.

DHTML (Dynamic HTML) is a standard for extending HTML that consists of HTML 4.0, DOM, CSS, and certain scripting languages.

DocBook refers to XML and SGML DTDs and DSSSL/XSL stylesheets owned by OASIS for use in modeling manuals and converting them.

DocZilla is the Web browser offered by CITEC that can render XML, SGML, and HTML documents.

DTD Document Type Definition refers to a specification for schema specification for SGML and XML documents. The DTDs can be contained within a document or belong to an external subset that is referenced. Examples of DTDs include HTML, DocBook, CML, and IBTWSH. ebXML electronic business XML, A project jointly initiated by UN/CEFACT (e.g., the United Nations body for Trade Facilitation and Electronic Business) and OASIS to standardize XML business specifications. ebXML intends to develop a technical framework that will enable XML to be utilized in a consistent manner for the exchange of all electronic business data.

FTP File Transmission Protocol refers to an application protocol for exchanging files over top of TCP/IP. FTP can be used to upload a webpage to a server.

HTML Hypertext Markup Language is a DTD that consists of both text and tags widely used for performing document layout and performing hyperlinking. Java applets can be included using an <APPLET> tag. The current W3C version of HTML is HTML 4.0, which is also known as XML-compatible HTML (XHTML).

HTTP Hypertext Transfer Protocol is the application protocol that controls the exchanging of files on the Web, and is within the architectural domain of W3C. IE Internet Explorer, the leading web-browser offered by Microsoft and provided free-of-charge with Microsoft operating systems.

Internet is a worldwide system of computer networks based on the TCP/IP set of protocols. Its most widely used parts are electronic mail (e-mail) and the World Wide Web (WWW).

Intranet A private network that is contained within an enterprise using TCP/IP, HTTP, and other Internet protocols. Intranets may include connections through gateway computers to the Internet using firewall servers for security.

IP (Internet Protocol) is a protocol in the TCP/IP internet layer for communication between nets and their hosts.

An IP-address uniquely identifies each network and each of its hosts on the internet. Addresses consist of four bytes that can be represented by four integers (0 to 255) separated by dots, e.g. “157.189.162.75”. Dependent on the address' class and a subnet mask, a specific number of bits identify the net or subnet and the rest a PC's address within this net/subnet.

ISO is the acronym for the International Organization for Standardization, which is an influential international federation of national standards organizations from over 500 countries.

Java is an object oriented programming language that is cross-platform compatible and supports multithreading. Java is executed on any platform using the Java Virtual Machine (JVM).

Java Applet component written in Java that can be downloaded from a server via an intra- or internet and executed on a client. The applet runs in a sandbox, e.g. the security settings only allow the applet to access data located on the server the applet is downloaded from. Most browsers contain a Java Virtual Machine (JVM) and are thus capable of running applets.

JavaBeans refers to a Java component model where reusable “beans” are created using a Bean Development Kit (BDK).

Netscape Navigator refers to Netscape's web-browser, which is currently Navigator part of Netscape Communicator.

SGML (Standard Generalized Markup Language) is the standard for documents adopted in 1986 by the ISO for defining documents using DTDs. Document contents are identified by using semantic tags.

Tag is a vanilla term for a language element descriptor.

Markup usually refers to the set tags for a document.

TCP (Transmission Control Protocol) is a transport layer protocol, which is used to establish a proper connection (hand shaking) before any data is transmitted.

TCP/IP (Transmission Control Protocol/Internet Protocol) refers to the two primary Internet protocols, namely the Internet Protocol IP (from which colloquial usage of the term “Internet” comes) and Transport Protocol TCP. It can also refer to certain application protocols, including FTP and telnet.

URL (Universal Resource Locator) refers to the unique address of a document or a resource on the Internet.

W3C is the World Wide Web Consortium an influential industry consortium promoting and maintaining the standards for the Web. The consortium also handles interoperability issues between Web products through its production of specifications and reference software.

WAP (Wireless Application Protocol) refers to the primary standard for accessing the Internet using wireless devices.

WML (Wireless Markup Language) refers to the DTD used in WAP. (see above)

WWW (World Wide Web, or simply Web) refers to the resources and users on the “Internet” using the Hypertext Transfer Protocol (HTTP).

XHTML (Extensible HyperText Markup Language) refers to a reformulation of HTML 4.0 in XML 1.0.

XMLHTTP refers to “Microsoft.XMLHTTP” or an “XMLHttpRequest Object”, which refer to the ActiveXControl enabling access to instances of HTTP request.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the representative embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A portable healthcare data security key for an individual, the key being configured for use in combination with a portable electronic data access device having a computer processor, a communications network interface, a first close proximity interface, a user interface, and a user display, the processor configured to operate the network interface, the first close proximity interface, the user interface and the user display, the user interface configured to enable operative communication between a user and the processor, the combination enabling the access device to retrieve the individual's electronically stored personal medical records from a remote electronic database that is communicatively connected to the network, the key comprising:
a. a body;
b. a memory unit configured to store an electronic security protocol adapted to allow electronic access to the database; and
c. a second close proximity interface configured to communicate with the access device's first close proximity interface to enable the key to operatively communicate with the access device when the key is in close proximity to the access device;
wherein the key is configured to communicate the security protocol to the access device through the first and second close proximity interfaces when the key is in operable communication with the access device to allow the access device to utilize the communications network to remotely access and retrieve at least a portion of the individual's electronically stored medical records from the database and display those retrieved medical records on the access device's user display.

2. The security key of claim 1, wherein the access device comprises a cellular telephone, a computer tablet or a laptop computer.

3. The security key of claim 1, wherein the access device network interface is wireless.

4. The security key of claim 3, wherein the communications network comprises a cellular network or the Internet.

5. The security key of claim 1, wherein the communications network comprises the Internet, the database is accessible through the Internet, and the security protocol comprises computer executable instructions that direct the access device to link to the Internet to access the database and retrieve the medical records.

6. The security key of claim 1, wherein the security protocol comprises one of either a code or a cipher.

7. The security key of claim 1, wherein the key comprises a user interface that is configured to enable a user to input at least a portion of the security protocol into the key's memory unit.

8. The security key of claim 1, wherein the first and second close proximity interfaces are wireless.

9. The security key of claim 8, wherein the access device's first close proximity interface comprises a Near Field Communication protocol component.

10. The security key of claim 8, wherein the key's second close proximity interface comprises a Near Field Communication protocol component.

11. The security key of claim 1, wherein the key's second close proximity interface comprises passive electronic circuitry that requires activation from the access device's first close proximity interface to enable the key to operatively communicate with the access device.

12. The security key of claim 1, wherein the key's second close proximity interface comprises active electronic circuitry that requires no activation from the access device's first proximity device to enable the key to operatively communicate with the access device.

13. The security key of claim 1, wherein the key's second close proximity interface comprises an encoded magnetic strip positioned on the key and the access device's first close proximity interface comprises a reader configured to read the magnetic strip, the magnetic strip containing a magnetic profile that stores the security protocol, and the access device is adapted to read the security protocol from the magnetic strip.

14. The security key of claim 1, wherein the key communicates a set of computer processor executable instructions to the access device, the instructions configured to enable the access device to utilize the communications network to remotely access and retrieve at least a portion of the electronically stored medical records of the individual from the database.

15. The security key of claim 1, wherein the access device user interface comprises one or more of a keyboard, a touchscreen, a touchpad and a voice recognition system.

16. A system for remotely retrieving an individual's personal medical records comprising:
a. a portable electronic data access device having a computer processor, a communications network interface, a first close proximity interface, a user interface, and a user display, the processor configured to operate the network interface, the first close proximity interface, the user interface and the user display, the user interface configured to enable operative communication between a user and the processor;
b. a communications network that is accessible by the access device through the network interface;
c. an electronic database that is communicatively associated with and accessible through the network, the database including electronic data containing personal medical records of the individual; and
d. a portable security key comprising a second close proximity interface and a memory unit, the first and second close proximity interfaces configured to communicate with each other to enable the key to operatively communicate with the access device when the key is in close proximity to the access device, the memory unit storing an electronic security protocol adapted to allow electronic access to the database, the key configured to communicate the security protocol to the access device through the first and second close proximity interfaces when the key is in operable communication with the access device to allow the access device to utilize the network to remotely access and retrieve at least a portion of the electronic data containing personal medical records of the individual from the database and display those retrieved medical records on the user display.

17. The system of claim 16, wherein the access device comprises a cellular telephone.

18. The system of claim 16, wherein the communications network comprises a cellular network.

19. The system of claim 16, wherein the communications network comprises the Internet.

20. The security key of claim 19, wherein the database is accessible through the Internet, and the security protocol comprises computer executable instructions that direct the access device to link to the Internet to access the database and retrieve the medical records.

21. The security key of claim 16, wherein the security protocol comprises one of either a code or a cipher.

22. The system of claim 16, wherein the electronic data is protected by a security interface that requires an input of an electronic code to allow access to the electronic data, and the electronic security protocol comprises the electronic code.

23. The system of claim 16, wherein the key comprises a user interface that is configured to enable a user to input at least a portion of the security protocol into the key's memory unit.

24. The system of claim 16, wherein the first and second close proximity interfaces are wireless.

25. The system of claim 24, wherein at least one of the first and second close proximity interfaces comprises an electronic circuit.

26. The system of claim 25, wherein the key's second close proximity interface comprises passive electronic circuitry that requires activation from the access device's first close proximity interface to enable the key to operatively communicate with the access device.

27. The system of claim 26, wherein the key's passive electronic circuitry comprises a Near Field Communication protocol component.

28. The system of claim 25, wherein the key's second close proximity interface comprises active electronic circuitry that requires no activation from the access device's first proximity device to enable the key to operatively communicate with the access device.

29. The system of claim 28, wherein the key's active electronic circuitry comprises a Near Field Communication protocol component.

30. The system of claim 25, wherein the key's second close proximity interface comprises an encoded magnetic strip positioned on the key and the access device's first close proximity interface comprises a reader configured to read the magnetic strip, and the magnetic strip contains a magnetic profile that stores the security protocol, and the access device is adapted to read the security protocol from the magnetic strip.

31. The system of claim 16, wherein the key communicates a set of computer processor executable instructions to the access device, the instructions configured to enable the access device to utilize the communications network to remotely access and retrieve at least a portion of the electronic data containing personal medical records of the individual from the database.

32. The system of claim 16, wherein the key comprises an ornamentation that can be worn by the individual.

33. The system of claim 16, wherein the access device network interface is wireless.

34. The system of claim 16, wherein the access device user interface comprises one or more of a keyboard, a touchscreen, a touchpad and a voice recognition system.

35. A method for a first person in proximity to a second person to obtain electronic medical records of the second person from a remote location, the first person possessing a portable electronic data access device having a computer processor, a communications network interface, a first close proximity interface, a user interface, and a user display, the processor configured to operate the network interface, the first close proximity interface, the user interface and the user display, the user interface configured to enable operative communication between the first person and the processor, the method comprising:
a. communicatively associating an electronic database with the communications network;
b. storing at least a portion of the second person's medical records in the database;
c. associating an electronic security measure with the medical records stored in the database to prevent electronic access to said medical records without electronic authorization from the second person;
d. forming/constructing a portable security key comprising a second close proximity interface and a memory unit;
e. storing an electronic security protocol in the memory unit, the protocol adapted to provide the electronic authorization to allow electronic access to at least a portion of the second person's medical records stored in the database;
f. configuring the first and second close proximity interfaces to communicate with each other when the access device is in close proximity to the key;
g. positioning the access device in close proximity to the key;
h. communicating the electronic authorization from the key to the access device through the first and second close proximity interfaces;
i. remotely accessing the database by the access device through the network using the electronic authorization; and
j. retrieving from the database by the access device at least a portion of the second person's personal medical records electronically stored in the database.

36. The method of claim 35, further comprising the step of displaying at least a portion of the retrieved medical records on the user display of the access device.

37. The method of claim 35, wherein one of said first and second close proximity interfaces comprises a Near Field Communication protocol component.

38. The method of claim 35, further comprising the steps of storing emergency contact information for the second person; storing computer processor executable instructions configured to enable communication with one or more of the emergency contacts for the second person; sending an alert to one or more of the second person's emergency contacts when the access device retrieves at least a portion of the second person's medical records from the database.
